(19) United States
(12) Patent Application Publication
(10) Pub. No.: US 2019/0382990 A1
(43) Pub. Date: Dec. 19, 2019

(54) ULTRASONIC FAUCET

(71) Applicant: Spectrum Brands, Inc., Middleton, WI (US)

(72) Inventor: Adam Tracy, Irvine, CA (US)

(21) Appl. No.: 16/444,265

(22) Filed: Jun. 18, 2019

Related U.S. Application Data
(60) Provisional application No. 62/686,142, filed on Jun. 18, 2018.

(51) Int. Cl. E03C 1/05; F16K 31/02; G10K 11/26; E03C 1/04

(52) U.S. Cl. CPC E03C 1/055; F16K 31/02; F16K 11/02; E03C 1/04; G10K 11/26

(57) ABSTRACT

A faucet may be used to deliver water in a temperature and volume controlled manner. The faucet may also selectively deliver an ultrasonic waveform within the water. The ultrasonic waveform is generated by an ultrasonic transducer that may be located within a head of the faucet, body of the faucet, or remotely located below a counter. An ultrasonic waveform generator controls the amplitude and frequency of the ultrasonic emissions. The ultrasonic waveform increases the cleaning ability of the water provided by the ultrasonic faucet by producing a plurality of agitated bubbles within the delivered water.

### CROSS REFERENCE TO RELATED APPLICATION

This application claims the benefit of U.S. Provisional Patent Application Ser. No. 62/686,142, filed Jun. 18, 2018, which application is hereby incorporated by reference in its entirety.

### TECHNICAL FIELD

This invention relates to faucets. More particularly, the invention is related to the field of electronic-equipped faucets.

### BACKGROUND OF THE INVENTION

Faucets are known to dispense water. Water from faucets is not only used for drinking but it is also useful in cleaning operations. The dispensed water is typically delivered by the faucet in any one of a cold state, a hot state, and a mixed state of hot and cold water blended together for a desired temperature.

Cleaning operations with dispensed water may include washing dishes, washing hands, washing cooking utensils, or washing any other soiled product. There are many accessories currently marketed to assist with washing operations. Such accessories include cleaning solutions, scrubbing tools, and various abrasives. While there have been great advances in the technology of cleaning solutions, abrasives, and scrubbing tools in recent years, there has not been much attention paid to the main cleaning solvent used, i.e., water.

Water in its basic form is an excellent solvent. It is very useful in breaking down dirt, grease, and any other grime collected on the object being cleaned. However, further enhancements to use of water continue to be sought to simplify and improve cleaning processes without compromising other characteristics (e.g., potability) of the water dispensed.

### SUMMARY OF THE INVENTION

A faucet may be equipped to emit ultrasonic waves. Preferably, the faucet includes a body with a central passage configured for mounting to a counter. A mixing valve within the body is configured to control delivery of water through the body. A cold water supply line and a hot water supply line are joined to the mixing valve for delivery of a cold and a hot water, respectively. A head is removably joined to the body and in fluidic communication with the mixing valve via a mixed water delivery line. A spout on the head is joined to the mixed water delivery line and configured to deliver a mixed water when the mixing valve is activated.

An ultrasonic transducer within the body is configured to transmit a waveform with at least one ultrasonic frequency into at least one of the cold water, the hot water, and the mixed water within the mixed water line when the mixing valve is activated. The mixed water delivered from the spout includes the waveform within the mixed water. An ultrasonic waveform generator is also contained within the body and configured to compute an ultrasonic frequency and an amplitude for the waveform produced by the ultrasonic transducer. An electrical power supply is configured to deliver an electrical current to the waveform generator and the ultrasonic transducer to power the waveform generator and ultrasonic transducer.

An air injection mechanism injects air into the mixed water delivery line and includes at least one of an aerator and a Venturi tube. The air injection mechanism may be either upstream or downstream of the ultrasonic transducer.

In order to control the temperature of the water delivered from the spout, a controller is included on the body and configured to control delivery of the hot, the cold, and the mixed water through the body, wherein the mixed water is a combination of hot and cold water in variable proportions, and wherein the variable proportions are controlled by the controller. The controller thereby includes a plurality of settings configured to deliver a unique proportion of hot water, cold water, and mixed water. Also, the controller may include an adjustment for at least one of the frequency and amplitude of the waveform. The control for the frequency and amplitude of the waveform may also be separate from the controller. The adjustable ultrasonic frequency may be selected from a range consisting essentially of 20,000 Hz to 3 GHz.

In other embodiments, the ultrasonic transducer may be within the mixing valve. The ultrasonic transducer may also be configured to only transmit the waveform when the controller, or other control, is in an ultrasonic position. The controller may also be an electronic controller configured to operate the mixing valve electronically. An aerator may be included in the spout, and the ultrasonic transducer may also be integrated with the aerator in the spout. The ultrasonic transducer may be located anywhere to transmit the ultrasonic waveform into the mixed water within the mixed water delivery line.

### BRIEF DESCRIPTION OF THE DRAWINGS

The present disclosure will be described hereafter with reference to the attached drawings which are given as non-limiting examples only, in which:

FIG. 1 shows a front view of an ultrasonic faucet mounted to a counter according to one embodiment of the invention;

FIG. 2 shows a sectioned view of an ultrasonic faucet mounted to a counter according to a second embodiment of the invention;

FIG. 3 shows a sectioned view of a head of an ultrasonic faucet according to a third embodiment of the invention; and

FIG. 4 shows a sectioned view of an ultrasonic faucet and a spray wand according to a fourth embodiment of the invention.

Corresponding reference characters indicate corresponding parts throughout the several views. The exemplifications set out herein illustrate an embodiment of the invention, and such exemplifications are not to be construed as limiting the scope of the invention in any manner.

### DETAILED DESCRIPTION

In accordance with the present disclosure, a water discharge fixture, such as a faucet, may be enhanced with features allowing it to emit ultrasonic waves that may be carried by dispensed water. Such a water discharge fixture may be used in instances where it may enhance the water's cleaning ability as it exits the water discharge fixture in such a way that the amount of cleaning solution (e.g., water) required is reduced. Additionally, the amount of manual agitation required to perform basic cleaning operations may be reduced. Furthermore, the enhancement of water as it exits the water discharge fixture is accomplished without compromising the potability of the water, in instances where the water discharge fixture is also used to dispense drinking water (e.g., in faucet applications).

In accordance with the present disclosure, although the ultrasonic wave emission described herein is described primarily in connection with use in a faucet, it is recognized that other types of water discharge fixtures may be used as well, particularly in instances where the fixture discharges water used for either of cleaning operations or drinking. For simplicity, the present disclosure describes certain features as implemented in the context of a faucet, but it is recognized that such features are applicable to any type of water discharge device, such as a showerhead, hand sprayer, etc.

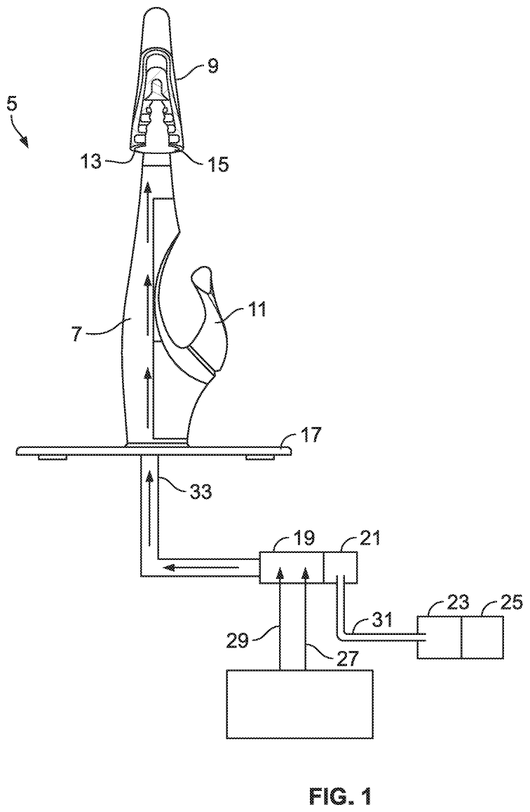

Referring now to FIG. 1, an ultrasonic faucet 5 is shown. In the example shown, the ultrasonic faucet 5 is mounted to a counter 17. The ultrasonic faucet 5 includes a body 7 joined to the counter 17. A controller 11 extends from the body 7. Manipulation of the controller 11 allows an operator to adjust both a volume and a temperature of the water delivered by the ultrasonic faucet 5. The controller 11 may be manipulated in any known manner including pivoting and rotating in multiple axes.

The controller 11 regulates the volume and temperature of delivered water by adjusting a mixing valve 19. The mixing valve 19 is shown mounted below the counter 17 and remote from the body 7. In this embodiment, the mixing valve 19 is controlled remotely by the controller 11. The controller 11 may be manipulated to regulate the water volume flow rate of hot water and colder water delivered from a hot water line 29 and a cold water line 27, respectively, where it is mixed in the mixing valve 19. A mixed water delivery line 33 is fluidically connected to the mixing valve 19, and supplies the ultrasonic faucet 5 with mixed water. The flow rate and the temperature of the water in the mixed water delivery line 33 may be adjusted with the controller 11 such that only cold water or only hot water may also be supplied by the mixing valve 19 to the mixed water delivery line 33. The flow rate may also be shut off completely by adjusting the controller 11. The controller 11 may electronically control the mixing valve 19 either by remote, wireless control, or through a wired control. It is also foreseeable that the controller 11 may be mechanically linked to the mixing valve 19 thereby allowing for mechanical control.

In the example shown, the mixed water delivery line 33 extends from the mixing valve 19 which is under the counter 17. The mixed water delivery line 33 then passes through the counter 17 and into the body 7. The body 7 therefore includes a hollow interior through which the mixed water delivery line 33 and any other devices or electronics may pass. A head 9 also contains a hollow interior through which the mixed water delivery line 33 passes. The mixed water delivery line 33 terminates inside the head 9 at the spout 13. The spout 13 delivers the water from the mixed water delivery line 33. An aerator 15 is also included in a spout 13. The aerator 15 introduces air into the water delivered by the mixed water delivery line 33.

As previously discussed, the controller 11 allows a user to control the volume and temperature of the water delivered from the spout 13. While the temperature and volume of the water flow are regulated by the mixing valve 19, an ultrasonic waveform is generated by an ultrasonic transducer 21. The ultrasonic transducer 21 introduces the ultrasonic waveform into the water within the mixed water delivery line 33. As a result, either the hot water, cold water, or any ratio of blended hot and cold water within the mixed water delivery line 33 is capable of carrying the ultrasonic waveform.

The ultrasonic transducer 21 creates cavitation bubbles induced by high frequency sound waves to agitate the water in the mixed water delivery line 33. The agitation produces forces that may be applied to any debris adhering to substrates like pots, pans, dishes, glassware, utensils, and the like. The forces transferred by the cavitation bubbles and agitated water also penetrate cracks, recesses, and any nooks and crannies that traditional washing and scrubbing are not able to reach.

While energy is transferred into the water within the mixed water delivery line 33 by the ultrasonic transducer 21, the actual waveform, i.e. the amplitude and frequency of the ultrasonic wave, is determined by a waveform generator 23. The waveform generator 23 may either be pre-programmed with an optimal amplitude and frequency at which the ultrasonic transducer 21 operates, or the controller 11 may include an input that allows the user to fine-tune the amplitude and frequency at which the ultrasonic transducer 21 operates. In some instances, a waveform of fixed amplitude and frequency is used; in alternative instances, a variable-frequency or variable-amplitude waveform is used, and overall energy (in terms of frequency range or amplitude range) may be controllable by the user. In example applications, the adjustable ultrasonic frequency may be selected from a range consisting essentially of 20,000 Hz to 3 GHz. However, other frequencies may be used as well, in alternative embodiments.

Accordingly, in example embodiments, the controller 11 may be movable among a plurality of selectable positions to select between hot water, cold water, a selectable ratio of hot and cold water, and an optional ultrasonic position in which the ultrasonic wave is generated and carried by the water that is emitted from the faucet 5. In example embodiments, the water emitted when the controller 11 is in the ultrasonic position may be any preselected temperature, or may be separately adjustable.

Information regarding the waveform prepared by the waveform generator 23 is communicated to the ultrasonic transducer 21 via communication line 31. The communication line 31 may allow for two-way communication between the ultrasonic transducer 21, the controller 17, and the waveform generator 23. Alternatively, the communication may occur wirelessly. The adjustment mechanism for fine-tuning the amplitude and frequency of ultrasonic emissions created by the ultrasonic transducer 21 may also be separate from the ultrasonic faucet 5 or may be directly on the waveform generator 23 and located below the counter 17.

A power supply 25 supplies the electrical power to the waveform generator 23 and the ultrasonic transducer 21. Preferably, the power supply 25 is connected to line-voltage from the dwelling's utility provider. Alternatively, the power supply 25 could be portable as with batteries which would allow installation of the ultrasonic faucet in locations without power.

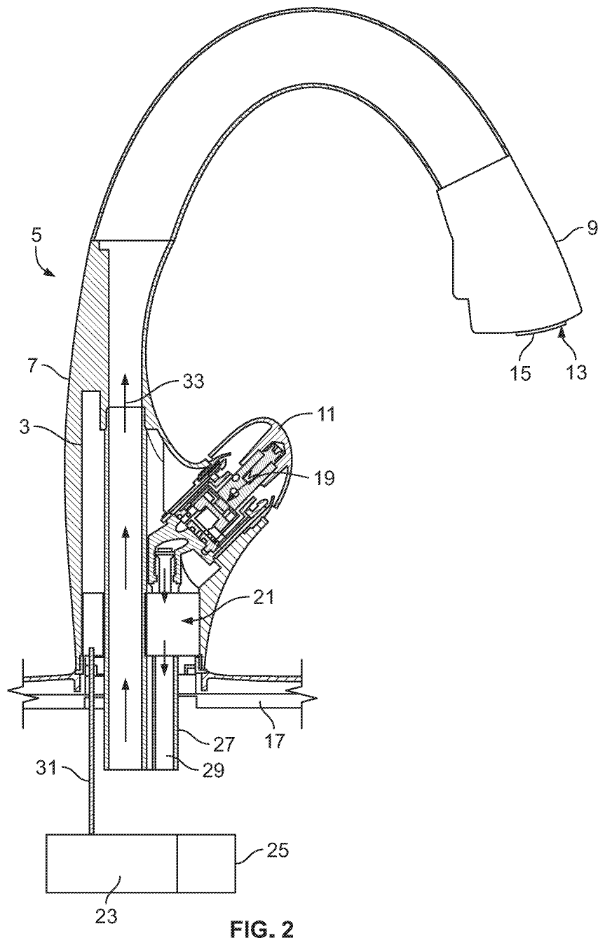

Switching now to FIG. 2, an alternative embodiment of the ultrasonic faucet 5 is shown. In this embodiment, the ultrasonic transducer 21 is included within the body 7 of the ultrasonic faucet 5. The ultrasonic faucet 5 in this embodiment also includes the mixing valve 19 within the body 7. As a result, the mixing valve 19 is mechanically linked to the controller 11. The controller 11 may therefore be manipulated to adjust the temperature and volume of the water passing through the mixed water delivery line 33 just as with the previous embodiment discussed with respect to FIG. 1.

The ultrasonic faucet 5 embodiment of FIG. 2 generally includes the same components as shown and disclosed with respect to FIG. 1. However, as seen in FIG. 2, the location of the ultrasonic transducer 21, location of the mixing valve 19, the routing of the hot water supply line 29, and the routing of the cold water supply line 27 differ from that seen in FIG. 1. Since, in the embodiment of FIG. 2, the mixing valve 19 is located within a central passage 3 of the body 7, the cold water supply line 27 and the hot water supply line 29 both connect to the mixing valve 19 within the central passage 3 of the body 7. The mixed water deliver line 33 is also connected to the mixing valve 19 and delivers the mixed hot and cold water away from the mixing valve 19 and then up through the body 7 of the ultrasonic faucet 5 and through the head 9 to the spout 13.

While the ultrasonic transducer 21 is located within the body 7 of the ultrasonic faucet 5, the power supply 25 and the waveform generator 23 are shown remotely located below the counter 17. The communication line 31 allows the waveform generator 23 to communicate with the ultrasonic transducer 21 while being remotely mounted under the counter 17. The remote mounting of the waveform generator 23 and power supply 25 frees up space within the central passage 3 of the body 7, allowing room for other things such as the cold water supply line 27 and the hot water supply line 29. The waveform generator 23 does not, however, need to be remotely mounted. It simply is in communication with the ultrasonic transducer 21, to allow the power supply 25 to deliver electrical energy to the ultrasonic transducer 21 and the waveform generator 23 for proper operation.

In this embodiment, the aerator 15 is also located in the spout 13 and injects air into the stream of water that exits the head 9. It is also contemplated that the aerator 15 may be located in another location such as within the body 7. The aerator 15 may also be any type of air injection mechanism such as a Venturi effect device. The aerator 15 may be installed upstream or downstream of the ultrasonic transducer 21. Similarly, the ultrasonic transducer 21 may be located anywhere where it can access the water flowing to and through the ultrasonic faucet 5.

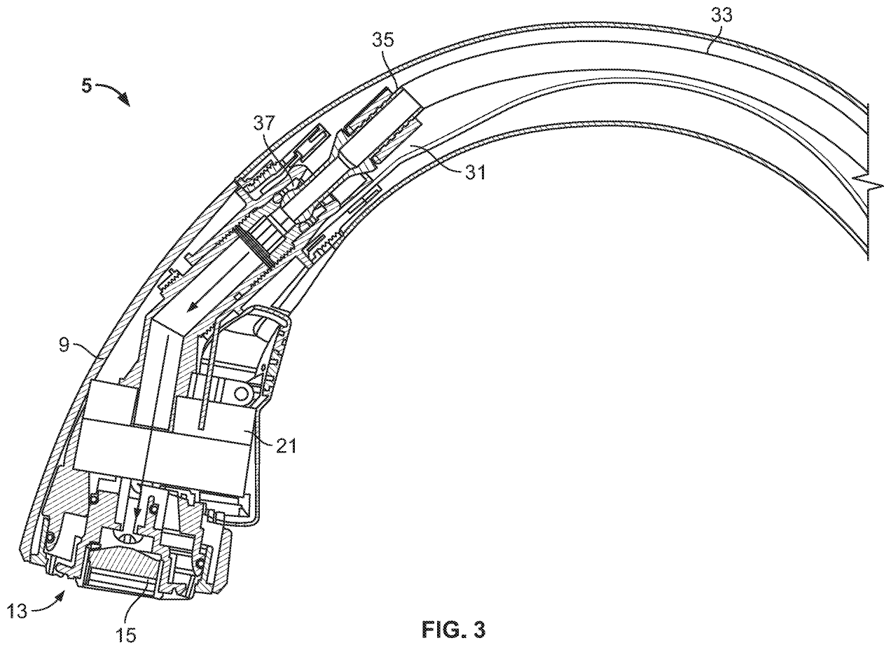

FIG. 3 shows yet another example embodiment of the ultrasonic faucet 5. In the embodiment shown, the ultrasonic transducer 21 is located within the head 9. As FIG. 3 is a sectional view, the insides of the head 9 are shown. The mixed water delivery line 33 is shown connecting to a mixed water delivery barb 35. The mixed water deliver barb 35 allows the head 9 to be detached while the mixed water delivery line 33 is tethered to the head 9. In this embodiment, there is a Venturi tube 37 that injects air into the mixed water within the mixed water delivery line 33. The air is injected through the Venturi effect. A Venturi tube 37 allows air bubbles from the ambient surrounding air to be inserted into flowing water from air inlet holes in the Venturi tube 37 which increases oxygen levels in the water in the form of air bubbles. A traditional aerator 15 is also shown in the spout 13. Either the Venturi tube 37 or the aerator 15 may be used to aerate the water. The Venturi tube 37 may also be located anywhere along the mixed water delivery line 33. Locating the air injection mechanism, e.g., aerator 15 or Venturi tube 37, either upstream or downstream of the ultrasonic transducer 21 will produce slightly different results. It is therefore contemplated that the waveform generator 23 can be tuned for the optimal frequency and amplitude to produce the best results which will change based on the specific location of the air injection and the ultrasonic transducer 21. Also, since the volume and temperature of the flowing water can be changed at any point, it is also foreseen that the waveform generator 23 can monitor the flow rate and temperature of the water passing through the mixed water delivery line 33 and calculate the most effective frequency and amplitude for the ultrasonic emissions generated by the ultrasonic transducer 21. The waveform communication line 31 allows the waveform generator 23 to communicate with the ultrasonic transducer 21, thereby allowing the waveform generator 23 to be located anywhere within the ultrasonic faucet 5 or remotely located.

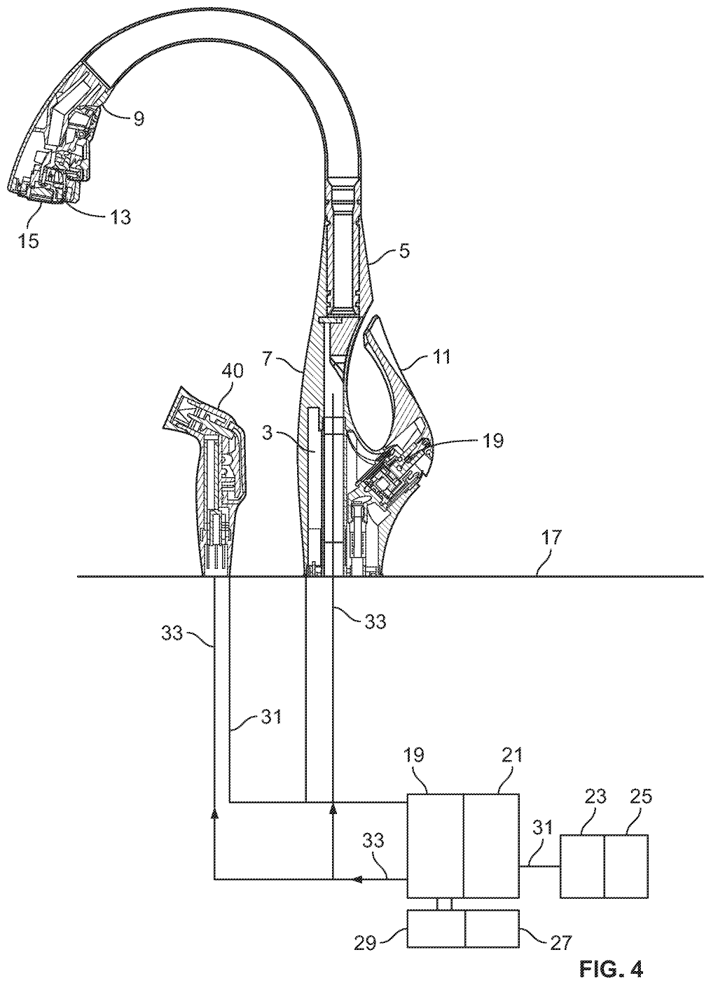

Turning now to FIG. 4, an additional embodiment is shown wherein the faucet 5 operates with all the features as disclosed with respect to FIG. 1. The hot water line 29 and the cold water line 27 supply water to the mixing valve 19 under the counter 17. The ultrasonic transducer 21 is also located below the counter 17 and is incorporated with the mixing valve 19. A communication line 31 allows an operator to control the water delivery with the controller 11 as well as with a spray wand 40. The waveform generator 23 determines the optimum frequency and amplitude for the ultrasonic waveform generated by the ultrasonic transducer 21. The user may selectively demand water with an ultrasonic waveform by depressing a button on the spray wand 40 or by manipulation of the controller 11. The demand for water with the ultrasonic waveform is transferred from one of the spray wand 40 and the controller 11 along the communication line 31 to the ultrasonic transducer 21 and waveform generator 23. The same ultrasonic transducer 21 may therefore transmit the ultrasonic waveform into water exiting the spray wand 40 and the head 9. It is, however, possible to configure the spray wand 40 to have its own ultrasonic transducer 21 that is separate from the ultrasonic transducer 21 of the ultrasonic faucet 5.

Although the present disclosure has been described with reference to particular means, materials, and embodiments, from the foregoing description, one skilled in the art can easily ascertain the essential characteristics of the present disclosure and various changes and modifications may be made to adapt the various uses and characteristics without departing from the spirit and scope of the present invention as set forth in the following claims.

1. An ultrasonic wave-emitting faucet comprising:
a body with a central passage configured for mounting to a counter;
a mixing valve within the body configured to control delivery of water through the body;
a cold water supply line and a hot water supply line joined to the mixing valve for delivery of a cold and a hot water, respectively;
a head removably joined to the body and in fluidic communication with the mixing valve via a mixed water delivery line;
a spout on the head joined to the mixed water delivery line configured to deliver a mixed water when the mixing valve is activated; and
an ultrasonic transducer within the body configured to transmit a waveform with at least one ultrasonic frequency into at least one of the cold water, the hot water, or the mixed water within the mixed water line when the mixing valve is activated, and wherein the mixed water delivered from the spout carries the waveform within the mixed water.

2. The ultrasonic wave-emitting faucet according to claim 1, further comprising:
an ultrasonic waveform generator contained within body configured to compute an ultrasonic frequency and an amplitude for the waveform produced by the ultrasonic transducer; and
an electrical power supply configured to deliver an electrical current to the waveform generator and the ultrasonic transducer.

3. The ultrasonic wave-emitting faucet according to claim 1, further comprising an air injection mechanism including at least one of an aerator and a Venturi tube, and wherein the air injection mechanism is upstream of the ultrasonic transducer.

4. The ultrasonic wave-emitting faucet according to claim 1, further comprising an air injection mechanism including at least one of an aerator and a Venturi tube, and wherein the air injection mechanism is downstream of the ultrasonic transducer.

5. The ultrasonic wave-emitting faucet according to claim 1, further comprising a controller on the body configured to control the mixing valve for delivery of the hot, the cold, and the mixed water through the body, and wherein the controller includes a plurality of settings configured to each deliver a unique ratio of hot water, cold water, and mixed water.

6. The ultrasonic wave-emitting faucet according to claim 5, wherein the controller includes an adjustment for at least one of the frequency and amplitude of the waveform.

7. An ultrasonic wave-emitting faucet comprising:
a body with a central passage configured for mounting to a counter;
a controller on the body configured to control delivery of a hot, a cold, and a mixed water through the body;
a cold water supply line and a hot water supply line supplying the cold and the hot water, respectively, to a mixing valve remote from the body;
a head removably joined to the body and in fluidic communication with the mixing valve via a mixed water delivery line, wherein the mixed water delivery line is configured to deliver any of cold water, hot water, and a mixed water depending on the position of the controller;
a spout on the head joined to the mixed water delivery line configured to deliver the hot water, the cold water, and the mixed water when the mixing valve is activated; and
an ultrasonic transducer within the mixing valve configured to transmit a waveform with at least one ultrasonic frequency any one of the hot water, the cold water, or the mixed water when the controller is activated.

8. The ultrasonic wave-emitting faucet according to claim 7, wherein the controller is movable to a position selected from among a mixed position, a cold position, a hot position, and an ultrasonic position, wherein the ultrasonic transducer only transmits the waveform when the controller is in the ultrasonic position.

9. The ultrasonic wave-emitting faucet according to claim 7, wherein the controller includes an input to activate the ultrasonic transducer that is separate from a temperature control input.

10. The ultrasonic wave-emitting faucet according to claim 9, further comprising an ultrasonic adjustment input configured to allow a user input to adjust the frequency and amplitude of the waveform.

11. The ultrasonic wave-emitting faucet according to claim 7, wherein the controller is an electronic controller configured to operate the mixing valve electronically.

12. The ultrasonic wave-emitting faucet according to claim 7, further comprising an aerator in the spout, and wherein the ultrasonic transducer is integrated with the aerator.

13. An ultrasonic wave-emitting faucet comprising:
a body with a central passage configured for mounting to a counter;
a manually operable controller joined to the body for receiving an input regarding a demand for a water;
a mixing valve with a cold water supply line and a hot water supply line for delivery of a cold and a hot water, respectively, to the mixing valve, wherein the controller regulates mixing of the hot water and the cold water within the mixing valve;
a mixed water delivery line joined to the mixing valve and passing through the body for delivery of a mixed hot and cold water as well as all hot water and all cold water;
a head removably joined to the body and in fluidic communication with the mixing valve via the mixed water delivery line;
a spout on the head joined to the mixed water delivery line configured to deliver any one of the hot water, the cold water, and the mixed hot and cold water when the controller is selectively adjusted; and
an ultrasonic transducer within the head configured to transmit a waveform with at least one ultrasonic frequency into any one of the mixed hot and cold water, the hot water, or the cold water within the mixed water delivery line when the controller is activated.

14. The ultrasonic wave-emitting faucet according to claim 13, further comprising:
an ultrasonic waveform generator contained within one of the head and the body configured to compute an ultrasonic frequency and an amplitude for the waveform produced by the ultrasonic transducer; and
an electrical power supply configured to deliver an electrical current to the waveform generator and the ultrasonic transducer.

15. The ultrasonic wave-emitting faucet according to claim 13, wherein the controller includes a mixed position for delivery of hot and cold mixed water, a cold position for delivery of only cold water, a hot position for delivery of only hot water, and an ultrasonic position, wherein the ultrasonic transducer only transmits the waveform when the controller is in the ultrasonic position in any one of hot water, cold water, and mixed water.

16. The ultrasonic wave-emitting faucet according to claim 13, wherein the controller includes an input to activate the ultrasonic transducer that is separate from a temperature control input that controls temperature.

17. The ultrasonic wave-emitting faucet according to claim 16, further comprising an ultrasonic adjustment input configured to allow a user input to adjust the frequency and amplitude of the waveform.

18. The ultrasonic wave-emitting faucet according to claim 13, wherein the controller is an manual controller configured to operate the mixing valve mechanically.

19. The ultrasonic wave-emitting faucet according to claim 13, further comprising an air injection mechanism configured to introduce bubbles into the mixed water delivery line.

20. The ultrasonic wave-emitting faucet according to claim 17, wherein the ultrasonic frequency is selected from a range consisting essentially of 20,000 Hz to 3 GHz.
